(19) United States
(12) Patent Application Publication
(10) Pub. No.: US 2006/0013169 A2
(43) Pub. Date: Jan. 19, 2006

(54) RELIABLE MESSAGE DISTRIBUTION IN AN AD HOC MESH NETWORK

(75) Inventor: Lee Boynton, Lake Oswego, OR (US)

Correspondence Address: MARGER JOHNSON & MCCOLLOM, P.C., 210 SW MORRISON STREET, SUITE 400, PORTLAND, OR, 97204, US

(73) Assignee: Packethop, Inc., Redwood City, CA (US)

(21) Appl. No.: 11/054,080

(22) Filed: Feb. 8, 2005

Related U.S. Application Data
(60) Provisional application No. 60/543,352, filed on Feb. 9, 2004.

(51) Int. Cl. H04J 3/00

(52) U.S. Cl. 370/337

(57) ABSTRACT

Abstract of the Disclosure

A Data Distribution Service (DDS) transfers information between nodes in an ad hoc mobile mesh network. The DDS includes many different novel features including techniques for coalescing retransmit requests to minimize traffic, providing a reasonable level of reliability for event oriented communications, multicasting retransmissions for use by many nodes, and providing other optimizations for multicast traffic. The DDS uses UDP datagrams for communications. Communications operate in a truly peer-to-peer fashion without requiring central authority or storage, and can be purely ad hoc and not depend on any central server. The protocol is NACK-based, which is more suited to a mesh network than a traditional approach like TCP, which uses positive acknowledgements of all data. The DDS is amenable to very long recovery intervals, matching well with nodes on wireless networks that lose coverage for significant periods of time and also works well with constantly changing network topologies. Reliability can also be handled over a span of time that might correspond to losing wireless coverage.

### Detailed Description of the Invention

This application claims priority from U.S. Provisional Application Serial No. 60/543,352, filed February 9, 2004.

### BACKGROUND

FIG. 1 shows a typical mesh network 12 with a node A communicating with a node B through multiple hops, links, nodes 14, etc. The links 14 can be any combination of wired or wireless mobile communication devices such as a portable computers that may include wireless modems, network routers, switches, Personal Digital Assistants (PDAs), cell phones, or any other type of mobile processing device that can communicate within mesh network 12.

The network nodes 14 in mesh network 12 all communicate by sending messages to each other using the Internet Protocol (IP). Each message consists of one or more multicast User Datagram Protocol (UDP) packets. Each node 14 includes one or more network interfaces which are all members which may be part of a same multicast group. Each node has an associated nodeid used for identifying both the source and the intended set of recipients of a message. Because the messages are multicast, routing details are transparent to the application.

Transmission Control Protocol (TCP) is commonly used to provide reliability for point to point communication, using a direct Acknowledgement (ACK) based design, but in a multicast scenario with multiple peers, the more efficient approach is a Negative Acknowledgement (NACK) based design. That is, when data is successfully transmitted, no additional communication is needed to affirm that fact; there are no acknowledgements. When packet loss is detected, the NACK is sent back to the source to request retransmission. Sequence numbers are used to detect missing or out of sequence packets. The present invention is such a NACK-based design.

In mesh networks, it is necessary to maintain certain data consistency between the different nodes 14. For example, all the nodes 14 may need to know which devices are part of the same multicast groups. This requires all of the nodes 14 to have the same versions of different multicast tables. This is typically done by exchanging data between nodes 14 and then responding with NACK responses if the data is not successfully received. A substantial amount of bandwidth and processing resources are required to maintain data consistency between the different nodes 14. Current techniques for maintaining data consistency between different mobile nodes is also inefficient.

The present invention addresses this and other problems associated with the prior art.

### SUMMARY OF THE INVENTION

A Data Distribution Service (DDS) transfers information between nodes in an ad hoc mobile mesh network. The DDS includes many different novel features including techniques for coalescing retransmit requests to minimize traffic, providing a reasonable level of reliability for event oriented communications, multicasting retransmissions for use by many nodes, and providing other optimizations for multicast traffic.

The DDS uses UDP datagrams for communications. Communications operate in a truly peer-to-peer fashion without requiring central authority or storage, and can be purely ad hoc and not depend on any central server. The need for traditional acknowledgement packets can also be eliminated under normal operation. Such a NACK-based protocol proves to be more efficient than the traditional approach like TCP.

The DDS is amenable to very long recovery intervals, matching well with nodes on wireless networks that lose coverage for significant periods of time and also works well with constantly changing network topologies. Reliability can also be handled over a span of time that might correspond to losing wireless coverage.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a diagram of a mesh network.

FIG. 2 is a block diagram of a Data Distribution Service (DDS) provided in a mesh network.

FIG. 3 is a diagram of a source data packet.

FIG. 4 is a block diagram of a source node shown in FIG. 2.

FIG. 5 is a block diagram of a receiver node shown in FIG. 2.

FIG. 6 is a diagram showing different DDS messages.

FIGS. 7-11 show different communications scenarios that are provided by the DDS.

### DETAILED DESCRIPTION

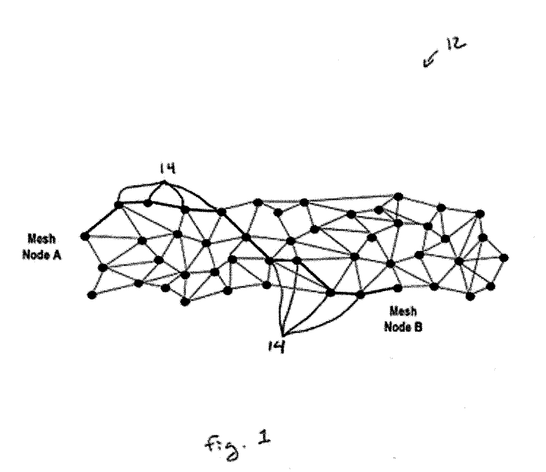

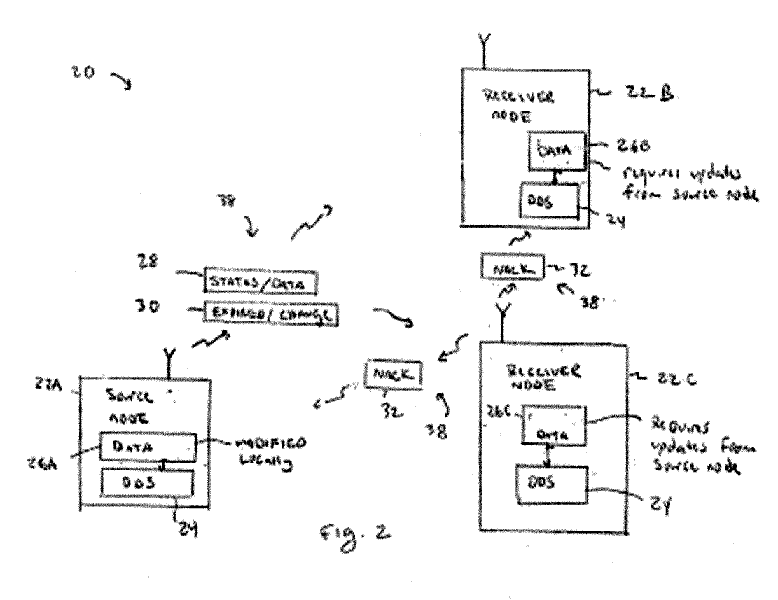

FIG. 2 shows several nodes 22 that may operate in a mesh network 20 similar to the mesh network 12 previously shown in FIG. 1. The nodes 22 can be any type of mobile device that conducts wireless or wired peer to peer mesh communications. For example, personal computers with wireless modems, Personal Digital Assistants (PDAs), cell phones, etc. Other nodes 22 can be wireless routers that communicate to other nodes through wired or wireless IP networks.

The mobile devices 22 can move ad-hoc into and out of the network 20 and dynamically reestablish peer-to-peer communications with the other nodes. It may be necessary that each individual node 22A, 22B and 22C have some or all of the same versions for different data items 26. The data items 26 in one example, may be certain configuration data used by the nodes 22 for communicating with other nodes. For example, the configuration data 26 may include node profile information, video settings, etc. In another example, the data 26 can include multicast information, such as multicast routing tables, that identify nodes that are members of the same multicast groups.

Data Distribution Service A Data Distribution Service (DDS) 24 is used to more efficiently maintain consistency between the data 26 in the different nodes 22. A source node 22A is defined as one of the nodes that may have internally updated their local data 26A and then sent out data message 28 notifying the other nodes 22B and 22C of the data change. Receiver nodes 22B and 22C are defined as nodes that need to be updated with the changes made internally by source node 22A.

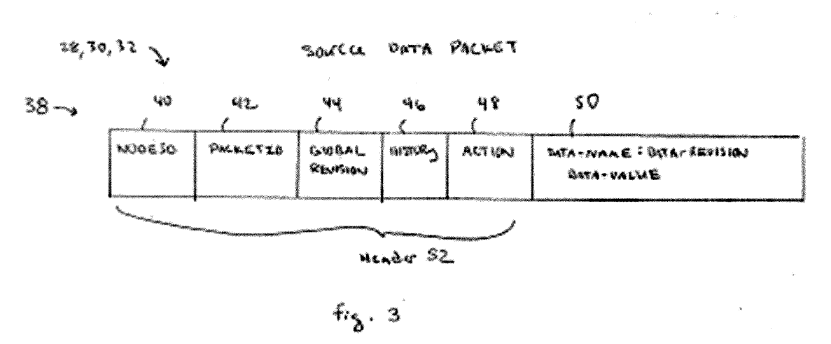

The DDS 24 sends and receives source data packets 38 as shown in FIG. 3 that are used in a variety of different ways. For example, the source data packet 38 can be used by the source node 22A to multicast a status or data message 28 that notifies other nodes 22B and 22C of a change in or current status for data 26A. In response to the multicast status or data message 28, the receiver nodes 22B or 22C may multicast a Negative Acknowledgement (NACK) message 32.

For example, the receiver node 22C may multicast NACK message 32 when data 26C is missing updates for some of the data items in data 26A. This could happen for example, when the mobile device 22C has temporarily been out of contact with mesh network 20 such that it did not receive a data message 28. In response to the NACK message 32, the source node 22A may multicast a repair message 30. The repair message 30 may provide information necessary to update data 26C in receiver node 22C and possibly data 26B in receiver node 22B with the latest changes made to data 26A. The repair message 30 in one example, may be an EXPIRED message indicating the requested data item is no longer available or a CHANGE message identifying the data items in data 26A that have been changed.

The Data Distribution Service (DDS) 24 in one implementation uses symbolic keys (data names) across all nodes in the mesh network 20 to maintain consistency between data items 26. The DDS 24 can be built within a reliable transport scheme or can be implemented as described below. The DDS 24 prevents data from being buffered persistently twice and retransmitting previous revisions of a particular data record, when only the most recent data item is required. This is a more complete design and solves the particular problems associated with replicating a "small" database across a mesh network.

Conceptually, DDS 24 works as an distributed hash table, binding keys (data names) to values (data). The nodes 22 talk to each other via the DDS protocol described below and use a single unified view of key-to-value (data name-to-data) mapping to maintain consistency of data 26 across the entire mesh network 20. Data consistency is provided by proactively replicating the database 26 in each node 22. The database 26 can include any object stored internally in the nodes 22.

Changes in data 26 is tracked by the DSS 24 across multiple network nodes 22 by detecting a global revision value for neighboring nodes, noting what revision of the data the local node already possesses, asking for change lists describing the delta between two such revisions, and potentially requesting retransmission of the missing data.

The DSS 24 thus maintains a set of data items 26 distributed across many nodes 22. The DDS 24 does not need to separately buffer transmissions like a reliable transport because the data 26 is already stored persistently before the communication commences.

Source Data Packets FIG. 3 shows one example of a source data packet 38 as previously described in FIG. 2. The source data packet 38 includes a header 52 that is used for conducting DDS operations. Some or all of the fields in header 52 may be used for sending messages 28, 30 or 32 described in FIG. 2. The source data packet 38 includes a nodeid field 40 that is unique to the originating node sending the message.

Every source data packet 38 includes a packetid field 42 that is global among all transmissions from the originating node sending the packet. The value in packetid field 42 is a monotonically increasing number. Receiver nodes, record packetids as the packets are received. The header 52 also includes a Global Revision Value (GRV) in global revision field 44 that identifies a latest revision to the data 26 in the node 22 sending the source data packet 38. The GRV defines a latest revision that has been made to the data 26 in a particular source node 22, regardless of the data item and what type of revision was made. For example, the GRV for source node 22A corresponds with the number of changes that have been made locally to data 26A (FIG. 2). So a first revision to a data item A would increment the GRV by 1 and a different revision to a different data item would cause the GRV to increment again by 1.

A history field 46 indicates how many packetids are remembered for possible retransmission. The GRV value and the history count in the history field 46 are each tracked by the nodes receiving the source data packets 38. The history field 46, in combination with the GRV 44, defines a window of packetids from the node 22 identified by nodeid field 40 that are available for retransmission. Communication of this history-based window allows peers to avoid sending a NACK for data that is known to be expired. It the responsibility of every receiver node 22 to then request retransmission of packets that it determines have not been successfully received.

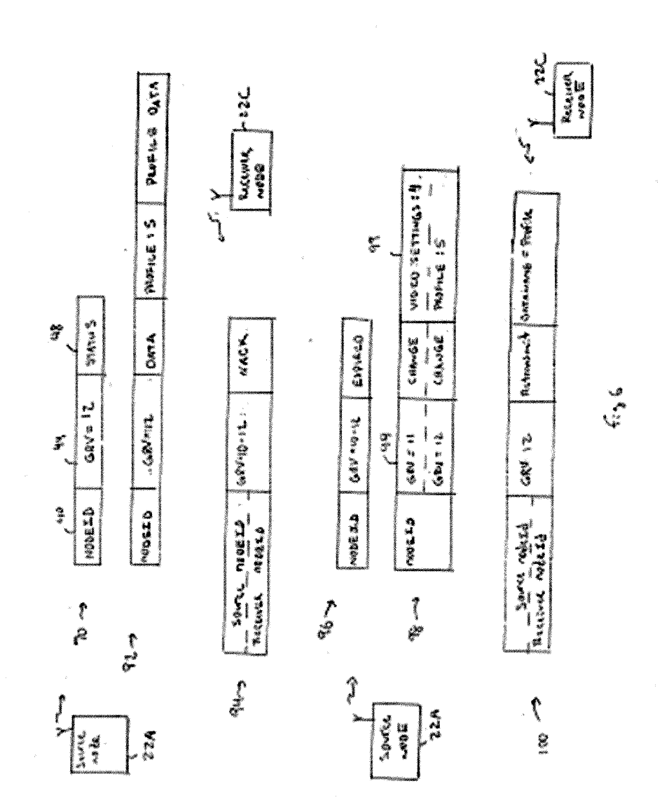

An action field 48 identifies a type of message that is associated with the source data packet 38. For example, the source data packet 38 may be used for sending a STATUS, DATA, NACK, EXPIRED, CHANGE, OR RETRANSMIT message as will be described in further detail below in FIG. 6.

Data Model A payload 50 is included in the source data packet 38. The payload 50 includes a data-name (key) and associated data-revision number. The data-name as described above is essentially a key identifying a particular data item. The data-revision number identifies a revision for the particular data item identified by the data-name.

For example, a fourth revision to a “profile” data item may have the entry “profile:4” in the payload 50. A fifth revision to a “video settings” data item would be identified in payload 50 as “video settings:5”. The payload 50 will also contain the actual revised data (data-value) as changed by the source node. By including some or all of the information in header 52 in the source data packet 38, no additional control traffic is required for maintaining consistency between the data 26 in the different nodes 22 (FIG. 2).

Note that the synchronization granularity is at the object level – the value of a key. All properties of an object (if relevant) are part of the object and do not need to be synchronized separately. The data 26 (FIG. 2) that is stored for each data-name has its own revision number (data-revision), so that a CHANGE message can coalesce multiple changes for a given datum down to the minimum when replicating over the mesh.

Data Protocol Every node 22 in the mesh network 20 (FIG. 2) emits its Global Revision Value (GRV) as part of every packet. As described above, changes to specific objects, or other data items in the node, can be tracked at a finer resolution with the second data-revision number that is associated with each individual data item.

When a receiver node, for example receiver node 22B or 22C in FIG. 2 finds “holes” in the transmission window defined by [GRV-history, data-revision], it sends a NACK message 32 back to the source node 22A to request a repair (FIG. 2). The actual NACK request may include multiple sequence numbers or GRV values so that NACK messages 32 are coalesced. The NACK message 32 may not be sent immediately, but may be sent after a random back-off interval. The back-off interval may be exponentially distributed. Because the repair packets are multicast, any node that requests a particular data item, could cause other nodes 22 to receive the same data item. The random back-off transmission period for NACK messages, allow other nodes to suppress similar NACK requests, thus reducing the number of NACKs that need to be sent.

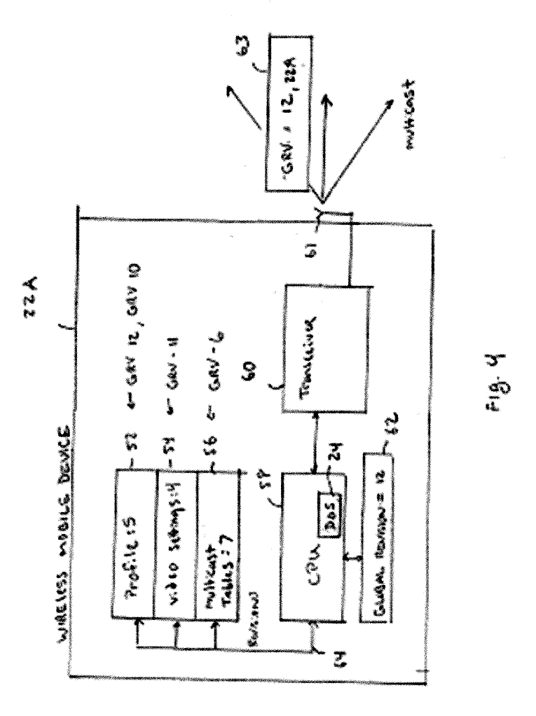

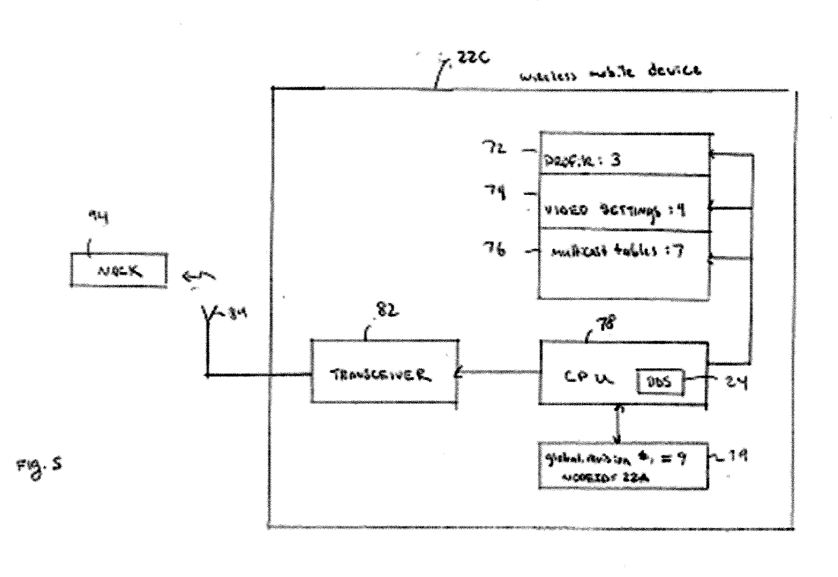

To explain further, FIG. 4 shows a source node 22A that includes a Central Processing Unit (CPU) 58 that operates software that provides the Data Distribution Service (DDS) 24. The CPU 58 wirelessly sends and receives DDS messages 63, via a transceiver 60 that is coupled to an antenna 61. Similarly, FIG. 5 shows a CPU 78 in one of the receiver nodes 22B or 22C that includes software for operating the DDS 24. The CPU 78 wirelessly sends and receive DDS messages via a transceiver 82 connected to an antenna 84.

The source node 22A in this example contains three different data items. Data item 52 contains profile data, data item 54 contains video settings, and data item 56 contains multicast tables or other types of configuration data. Each data item includes an associated data-revision number. For example, the profile data item 52 currently has a data-revision = 5 and the video settings 54 currently has a data-revision = 4.

The CPU 58 in the source node 22A also keeps track of the Global Revision Value (GRV) 62 that is associated with changes made to any of the data items 52, 54, and 56. In the example shown in FIG. 4, the CPU 58 has currently made twelve GRV changes to the data items 52, 54 and 56. The GRV 11 was made to data item 54 and the GRVs 10 and 12 were made to data item 52. Changes in the GRV 62 can also be attributed to multiple changes in the same data item. For example, GRV 10 is attributed to revision 4 for profile 52 and GRV 12 is attributed to revision 5 for profile 52.

For explanation purposes, the current state of receiver node 22C will be shown in FIG. 5. Receiver node 22C contains a “profile” data item 72, “video settings” data item 74 and a “multicast table” data item 76. The profile data item 72 currently has an associated data-revision number = 3 and the video settings data item 74 currently have a data-revision number = 4. The receiver node 22C keeps track a current Global Revision Value (GRV) 79 associated with source node 22A as GRV=9. For example, the last data update received from source node 22A had an associated GRV=9.

FIG. 6 shows the different DDS messages that can be sent by the DDS 24 in the different mesh nodes.

Status Message A STATUS message 90 is periodically sent by the source node 22A when no other packets are being sent. In one embodiment, the STATUS message 90 is sent out periodically to indicate nothing has changed. In the example shown in FIG. 6, the STATUS message 90 includes the nodeid 40 for the source node 22A and the Global Revision Value (GRV) 44 for the source node 22A. The action field 48 indicates the packet as a STATUS message. If the receiver node 22B or 22C has the same GRV 44 for the same nodeid 40, then no further action is required.

In the example shown in FIGS. 4 and 5, a status message 90 sent by source node 22A includes a GRV = 12 and the corresponding GRV in the receiver node 22C is GRV = 9. This prompts the receiver node 22C to send a NACK message 94.

Data Message A DATA message 92 is sent whenever the source node 22A changes, modifies, adds, removes, etc. a data item. The DATA message 92 carries the actual data that needs to be updated or added to all of the receiver nodes 22B and 22C. When data 26A (FIG. 2) is changed, the DATA message 92 is multicast out to the other nodes in the mesh network 20 and contains the data-name and its data-revision number. In this example, the DATA message 92 identifies data-name= profile and data-revision=5 and includes the actual updated version 5 profile data. The DATA message 92 also includes the latest global revision value GRV=12 for the source node 22A.

After receiving the DATA message 92, or the STATUS message 48, the receiver node 22C compares the GRV=12 in the DATA or STATUS message 92 with the most recently received GRV for that nodeid. Normally the GRV received from the source node 22A should be incremented by 1, corresponding to this packet's data change, in which case the local most recent revision from the source node is updated, with the data in data message 92.

Negative Acknowledgements (NACK) Every receiver node keeps track of received packets, adding the packetID and its received timestamp to its list of received packets, which is maintained on a per-source basis. For example, the source data packets 38 (FIG. 3) are indexed by the source nodeid. The receiving nodes also store the global revision value and history values for the other nodes and updates them for every received packet, if the GRV has changed.

The nodeids outside the window are removed from the list, and the resulting list is scanned for missing packetids. A NACK message 94 is sent by the receiver node when missing data is detected. An exponentially distributed random time interval can be calculated and used before sending out the NACK message 94. This prevents NACK implosion, where multiple receiver nodes try to send NACK messages 94 for the same requested packet at the same time. The receiver node 22C schedules itself to wake up after the random time interval to check the GRV again and to possibly send a NACK 94 corresponding to the missing source data packet 38.

As CHANGE messages 98 or EXPIRED messages 96 are received from source node 22A responsive to the NACKS 94, all pending NACKs are updated and received packets removed from the list. The NACK messages 94 received from other nodes that request the same information are also removed from the list. The packetids that fall outside the transmission window also get removed.

If a NACK list becomes empty while waiting, it gets completely removed. When a NACK message 94 gets sent, it is added to a repair-requested list with the timestamp of when it was sent. Similarly, subsequent NACKs sent by peers are also added to this list.

In the absence of any activity, the receiver node 22C still wakes up every so often to scan the lists of all nodes, and restart the NACK process for peers that are missing packets but have not had any other activity. This is retried until the lifetime of the packets has expired. The period of retrying could be adapted if no traffic at all is detected for a node. This could also better handle the case of a node completely disappearing from the mesh network 20.

If the receiving node 22C misses the DATA message 92, it won't be noticed until the next DATA, STATUS, EXPIRED, or CHANGE message is received from the source node 22A. All of these messages also include the global revision value (GRV) for the source node 22A. At that point, the receiving node 22C notes that the GRV 62 for the sender node 22A is greater than what it last saw (GRV=9), and multicasts the NACK message 94 identifying the GRV number, or numbers, it is missing.

For example, in FIG. 4, the CPU 58 may send out a status message 63 with a GRV = 12 and an associated source nodeid for source node 22A. The receiver node 22C has a current GRV for that source nodeid of GRV=9. Accordingly, the receiver node 22C multicasts a NACK message 94 as shown in FIG. 6 that identifies missing GRVs 10-12.

CHANGE, RETRANSMIT and EXPIRED Messages The source node 22A does not send the actual data in response to the NACK message 94. Alternatively, the source node 22A sends a changelist, enumerating the keys (data-names) and their specific data-revision numbers for the GRVs identified in the NACK message 94. The resulting CHANGE message 98 (FIG. 6), enumerates all the global revision values that are being addressed, and a list of key/values/revisions 99 that are associated with those global revision values. For example, in FIG. 4, the source node 22A may send back a CHANGE message 98 that includes data-name=video settings:4 for GRV = 11 and dataname=profile:5 for GRV = 12. The data itself for both the video settings and the profile may not be sent in the CHANGE message 98.

In another example, if a data item changes multiple times before another node notices, the single most current data can be sent out to satisfy older repair requests. This is accomplished with a CHANGE message 98, which identifies what older global revisions should be updated with a single new version of the data. In one implementation, older values are not kept and only the most current version of the data item and the corresponding revision number are maintained.

For example, in FIG. 4, the source node 22A might not send back the data-revision associated with GRV=10, since GRV=10 is associated with a previous older version of the profile 52 (data-name=profile, data-revision=4) that is no longer valid.

The receiver node 22C notes all the old global revisions that are being handled, and looks at the key/values/revisions to determine which keys it needs to request for retransmission, and sends a RETRANSMIT message 100 (FIG. 6) back to the source node 22A. For example, the “video setting” data item in the receiver node 22C in FIG. 5 has a data-revision value=4 for the nodeid associated with source node 22A. This is the same data-revision value indicated in CHANGE message 98 in FIG. 6. Therefore, the receiver node 22C does not send a retransmit request for the video settings.

The profile data item 72 in the receiver node 22C in FIG. 5 has a data-revision value = 3. However, the profile in the change message 98 in FIG. 6 has a data-revision value = 5. Thus, the receiver node 22C determines that current profile data item 72 is out of date. Accordingly, the CPU 78 in FIG. 5 sends a RETRANSMIT message 100 as shown in FIG. 6 that requests the source node 22A to send the profile data associated with GRV 12. The source node 22A responds to the RETRANSMIT message 100 by producing another DATA message 92 as shown in FIG. 6 that contains the profile data item 52 in FIG. 4.

Alternatively, if the profile data item 52 in FIG. 4 is no longer available, the source node 22A may send an EXPIRED message 96. This handles race conditions when the data expires while this exchange is happening. The EXPIRED indication can alternatively be part of the CHANGE message 98. If any of the intervening messages are lost, the whole process starts over.

When the source node 22A receives the NACK message 94 (FIG. 6), it first checks that the faulty packetid is within the transmission window. If not, it sends the EXPIRED message 96 indicating that peers should stop asking for it. If within the transmission window, the original data item is fetched and resent. The source data items remain in a sent packet list until its original lifetime has expired, independent of the number of retransmissions. The entry is updated to indicate the time of the most recent transmission.

If a NACK message 94 is received within a small time after a data packet is sent out by the source node 22A, it may be ignored with the assumption that the just sent data packet will satisfy the NACK 94. In the case of a race condition that fails in favor of dropping the NACK 94, the receiver node 22C will request the data item again.

Note that any node in the mesh network 20 (FIG. 2) that has the required repair data and mappings of global revisions to particular data revisions can respond to the NACK message 94. Thus, in the above discussion, the source node 22A can be any node that has the requested data. A random back-off delay is utilized to prevent every node from simultaneously doing so. This optional choice implies that the node providing the repairs store global revision to data revision mappings for all other nodes.

The protocol has another advantage in that the DDS message exchange prevents data from being sent multiple times, particularly for the case that a single key is getting repeatedly updated. In this case only the most current value will get transmitted, whereas with the reliable multicast transport, every change is sent, just to overwrite the previous value.

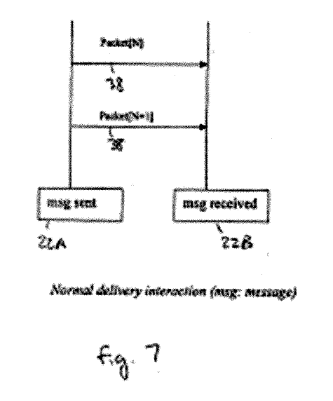

Scenarios FIGS. 7-11 explain some of the different DDS delivery scenarios that can occur during data consistency operations.

No errors, sequential delivery FIG. 7 shows one of the simplest cases, where the source data packets 38 (FIG. 3) are sent from source node 22A and successfully received sequentially in their original sending order by the receiver node 22B. Each packet N has a global version number that indicates that the packet being received is the most current, so no additional action need be taken.

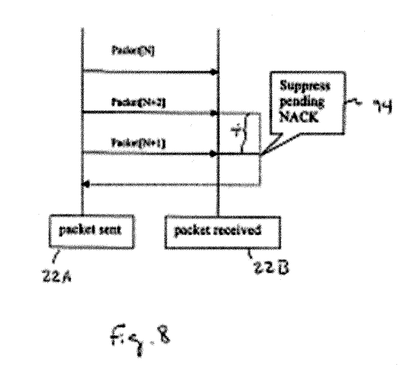

No errors, out of order delivery In the next case shown in FIG. 8, the source data packets are sent by the source node 22A and successfully received by the receiver node 22B, but their original order is not maintained. This causes a NACK message 94 (FIG. 6) to be sent after a random delay T, unless the "skipped" packet N+1 is received before that delay time T expires. FIG. 8 shows the case where the packet N+1 is received by the receiver node 22B before the expiration of random delay time T. In this case the NACK message 94 is suppressed.

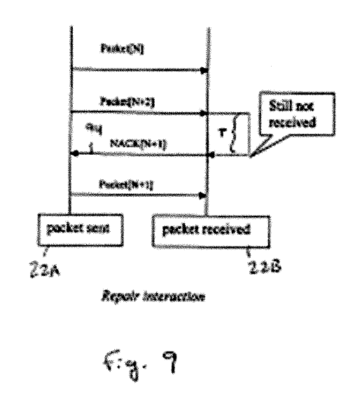

Simple Repair FIG. 9 shows the case when a packet sequence number skips by one and the missing source data packet N+1 has still not been received by the time the NACK message 94 is scheduled to go out. In this case, a NACK message 94 is pending and packet N+1 has not been received within time T. Accordingly, the receiver node 22B sends NACK message 94 to the source node 22A that identifies the source data packet N+1 as described above. The source node 22A through the DDS protocol (the CHANGE and RETRANSMIT messages are not shown) then resends the source data packet N+1.

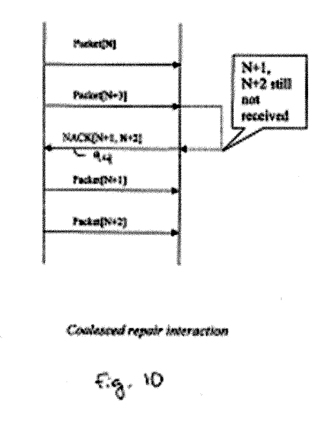

Coalesced Repair FIG. 10 shows the situation when more than one source data packet is detected as missing. The set of packet numbers, data items, or GRVs can be encapsulated into a single NACK message 94. At the time the NACK message 94 is ready to be sent (i.e. the soonest random backoff interval) all pending NACKs for packets N+1 and N+2 are included in NACK message 94. Again, the protocol between the NACK and the retransmission of the data is not shown.

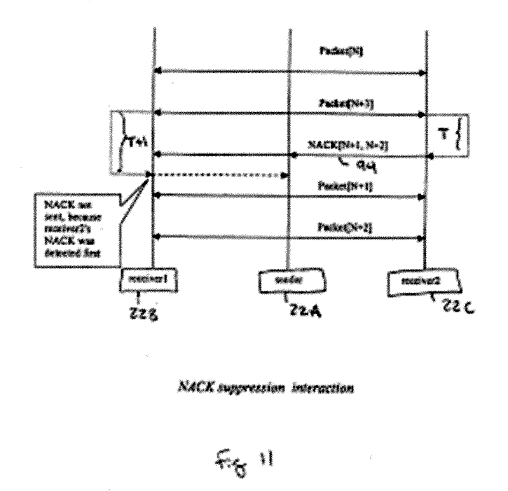

NACK suppression FIG. 11 shows the situation where multiple receiver nodes 22B and 22C detect missing packets. Each receiver node 22B and 22C could potentially send a NACK message 94. However, each receiver node 22B and 22C may use a random delay before sending their NACK message 94. This will likely cause one of the receiver nodes 22B or 22C to send a NACK message before the other receiver node.

For example, receiver node 22C is scheduled to send the NACK message 94 at random time interval T and receiver node 22B is scheduled to send the same NACK message 94 at random time interval T+1 after receiver node 22C. Because the NACK messages 94 are multicast, other nodes will see the first NACK message 94 sent by receiver node 22C. This causes receiver node 22B to suppress sending the same NACK message as long as the NACK message 94 received from receiver node 22C contains the packet ids missing in receive node 22B. The DDS protocol between the NACKs and the retransmission of the DATA is again not shown.

Additional Information The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

What is Claimed is:

1. A network processing node, comprising:
a processor sending Data Distribution Service (DDS) messages associated with data items contained in the network processing node, the DDS messages identifying a global revision value associated with a revision status for multiple different data items in the network processing node and data-revision numbers that identify revision status for the individual data items.

2. The network processing node according to claim 1 wherein the DDS messages include different node identifiers that are associated with different global revision values.

3. The network processing node according to claim 1 wherein the processor sends a STATUS message that identifies the network processing node sending the STATUS message and the global revision value associated with the last revision to the data items in the identified network processing node.

4. The network processing node according to claim 1 wherein the processor sends a DATA message that identifies:
the node sending the DATA message,
a global revision value for the node sending the DATA message,
a data-name identifying a data item contained in the DATA message,
a data-revision value for the data item, and
the actual data item identified by the data-name.

5. The network processing device according to claim 1 wherein the processor receives a Negative Acknowledge (NACK) message that identifies global revision values for data that was not successfully received.

6. The network processing device according to claim 5 wherein the NACK message identifies the network processing node associated with the identified global revision values.

7. The network processing device according to claim 5 wherein the NACK message contains a group of multiple global revision values each associated with the same or different data items that have not been successfully received.

8. The network processing device according to claim 5 wherein the processor sends a CHANGE message identifying for the global revision values identified in the NACK message a data-name identifying a data item and a data-revision number for the identified data item.

9. The network processing device according to claim 8 wherein the processor receives a RETRANSMIT message that identifies the data-names in the CHANGE message that are requested to be retransmitted, the processor in response to the RETRANSMIT message sending a DATA message that contains the data items for the identified data-names.

10. The network processing device according to claim 8 wherein the processor only sends global revision values and associated data-names in the CHANGE message only for the latest versions of the data items associated with the global revision values in the NACK message.

11. The network processing device according to claim 8 wherein the processor maintains time stamps for the data items and sends out EXPIRED messages for requested updates to data items with expired time stamps.

12. An ad-hoc mesh network, comprising:
multiple mobile nodes that operate in wireless peer-to-peer manner within the mesh network whereby the nodes can dynamically move out of the mesh network and are automatically reconfigured to resume communications after moving back into the mesh network,
at least some of the nodes operating a Data Distribution Service (DDS) that sends and receives DDS messages that use Global Revision Values (GRVs) for tracking changes to groups of different data items located on different nodes and for maintaining consistent versions of the data items on the different nodes.

13. The mesh network according to claim 12 wherein the DDS messages identify data-revision values for individual data items associated with the GRVs.

14. The mesh network according to claim 12 wherein a STATUS or DATA message is multicast by a source node to other receiver nodes in the mesh network that identifies a latest GRV for the source node.

15. The mesh network according to claim 12 wherein the receiver nodes compare the GRV for the source node to a local GRV value tracked for the same source node and send a Negative Acknowledge (NACK) message to the source node identifying any missing GRV values.

16. The mesh network according to claim 15 wherein each receiver node waits a random time delay period before sending the NACK messages and suppresses their NACK messages when another NACK message identifying the same GRV values is received from another receiver node prior to expiration of the random time delay period.

17. The mesh network according to claim 15 wherein the source node sends a CHANGE message to the receiver nodes that identifies only the data-names and data-revision numbers for the latest versions of data items associated with the GRV values identified in the NACK message.

18. The mesh network according to claim 15 wherein the source node identifies invalid locally stored data items and sends out an EXPIRED message for any of the GRV values in the NACK message that are associated with invalid data items.

19. The mesh network according to claim 18 wherein the source node generates time stamps for locally stored data items and invalidates data items that have expired time stamps.

20. A method for sending messages in a mesh network, comprising:
receiving a wireless message that identifies a global revision number for a remote set of multiple different data items located in a remote wireless device, the global revision number associated with a latest change made to any one of the data items;
comparing the received global revision number with a locally stored global revision number corresponding with a remote device sending the wireless message; and
sending a notice message when the received global revision number is different than the locally stored global revision number, the notice message identifying the global revision numbers associated with data items that have not yet been received from the remote device.

21. The method according to claim 20 including randomly varying a delay time for sending the notice message and suppressing the notice message when another notice message is received from another node identifying the same global revision numbers for the same remote device.

22. The method according to claim 20 including receiving a change message back from the remote device that identifies data names and associated data version numbers associated with the global revision numbers in the notice message.

23. The method according to claim 22 including using the data names and associated data version numbers to identify only a latest version of data items that have not yet been received from the remote device and sending a retransmit message to the remote device that contains the data names for the identified data items.

24. The method according to claim 23 including receiving a data message back from the remote device containing the data items for the data names identified in the retransmit message.
